(19) United States
(12) Patent Application Publication
(10) Pub. No.: US 2012/0163751 A1
(43) Pub. Date: Jun. 28, 2012

(54) REFLECTION TYPE OPTICAL DELAY INTERFEROMETER APPARATUS BASED ON PLANAR WAVEGUIDE

(75) Inventors: Jeong-Sik CHO, Daejeon-si (KR); Sae-Kyoung KANG, Daejeon-si (KR)

(73) Assignee: Electronics and Telecommunications Research Institute, Daejeon-si (KR)

(21) Appl. No.: 13/304,532

(22) Filed: Nov. 25, 2011

(30) Foreign Application Priority Data
Dec. 22, 2010 (KR) 10-2010-0132728

(51) Int. Cl. G02B 6/024

(52) U.S. Cl. 385/11

(57) ABSTRACT

A reflective type optical delay interferometer includes a coupler to divide an optical signal into two optical signals; a first optical waveguide connected to the coupler, to have a first optical delay path for transmitting a first optical signal which is one of the two optical signals; a second optical waveguide connected to the coupler, to transmit a second optical signal which is the other of the two optical signals and to have an optical delay path asymmetrical to the first optical delay path; and first and second polarization rotation reflection devices respectively connected to the first and second optical waveguides, wherein the first polarization rotation reflection device rotates polarizations of the first optical signal and the reflected first optical signal and the second polarization rotation reflection device rotates polarizations of the second optical signal and the reflected second optical signal.

### CROSS-REFERENCE TO RELATED APPLICATION

This application claims the benefit under 35 U.S.C. §119(a) of Korean Patent Application No. 10-2010-0132728, filed on Dec. 22, 2010, the disclosure of which is incorporated by reference in its entirety for all purposes.

### BACKGROUND

1. Field

The following description relates to a structure of an optical delay interferometer apparatus having a low polarization dependency and a technology of applying the optical delay interferometer apparatus to a communication system.

2. Description of the Related Art

A planar waveguide is an optical component which has a waveguide on a planar substrate to adjust the traveling direction of light such that the traveling characteristics of a beam are controlled. An optical device using the planar waveguide achieves a superior stability and a high degree of integration compared to an optical fiber based device. The planar waveguide is mainly applied to a silica based coupler, an array waveguide grating (AWG), an optical interleaver, a delay interferometer, in addition to, a Lithium Niobate (LiNbO₃) based amplitude modulator and phase shifter.

A method of manufacturing the planar waveguide is as follows. First, a core is formed by depositing core material of a waveguide having a predetermined reflective index on a planar substrate formed using silicon or silica and by etching the core material to correspond to the shape of a designed waveguide. Thereafter, material for clad is deposited. The planar waveguide includes a core provided in a rectangular shape and a clad layer formed of dissimilar material, causing a difference in pressure at perpendicular and horizontal directions. The difference in pressure at perpendicular and horizontal directions leads to birefringence characteristics that produce different indices of refraction depending on the polarization state of beam. The polarization dependent characteristics of an optical device are expressed as a polarization dependent loss (PDL) or a polarization mode dispersion (PMD), etc.

As described above, the planar waveguide shows a significant degree of polarization dependent characteristics due to a significant birefringence compared to an optical fiber based waveguide. In particular, if the planar waveguide is used for an asymmetric interferometer, such as a delay interferometer and an optical interleaver, a polarization dependent wavelength shift (PDWS) occurs due to the birefringence characteristics.

The PDWS represents a phenomenon in which a waveguide has different effective indices of refraction for beams that are input with different polarization modes from each other, such as a Transverse Electric (TE) polarization and a Transverse Magnetic (TM) polarization, and thus nulls of the interference spectrums do not match. However, if the PDWS occurs as much as several percents (%) to a free spectral range (FSR) of an interference spectrum, the effective bandwidth is narrowed, so that the characteristics of devices are degraded. In general, an asymmetric path of a delay interferometer has a great difference in length. Accordingly, the delay interferometer having a large asymmetric length difference produces a very narrow free spectral range compared to an optical interleaver and has a high susceptibility to the PDWS phenomenon.

According to a technology suggested as a solution for the PDWS of a planar waveguide based delay interferometer, a half wave plate is inserted in the middle of a delay line of a waveguide to convert a TE mode beam to a TM mode beam or vice versa such that the birefringence is canceled. The method mitigates the PDWS caused by the waveguide, however, the half wave plate is also dependent of polarization and causes a need for aligning the optical axis of the half wave plate with respect to the optical axis of the wave guide within a very small scale of error.

The planar waveguide is applied to a quantum key distribution (QKD) system with its superior stability. An interferometer used in the QKD system is a time-division optical interferometer (TDI) that performs a delay division on beams at a transmission unit and a reception unit to induce interference. The TDI is similar to a delay interferometer but has a configuration having an extended long path.

The TDI at the initial stage has been manufactured by use of optical fiber. The optical fiber based TDI has a low stability of polarization and phase. Accordingly, a polarization controller, polarization maintaining fibers and a phase controller have been used to improve the stability. In recent years, a technology for ensuring the polarization stability has been developed in which a Michelson interfereometer using a Faraday mirror is implemented. Still the instability of phase is not solved and requires a complex phase compensating device to be added.

In order to compensate for the instability of phase in optical fiber, there is a technology for applying a planar waveguide to a TDI. This technology ensures the phase stability, but causes a problem that polarization of input beam rotates due to birefringence, that is, inherent characteristics of a planar waveguide. If a planar waveguide based TDI is used for a quantum key distribution (QKD) system, the beams having been subject to time division at transmission/reception units may be output with different polarization states due to the birefringence of the planar waveguide.

Effective generation of optical interference requires two beams having the same phase states and the same polarization states. In order to match the polarization states, the polarization direction of beams introduced to a reception unit interferometer needs to be adjusted and two interferometers of the transmission unit and the reception unit need to apply the same variation of polarization to beams.

Birefringence causes the polarization direction to be changed at a predetermined period in a length direction. The length of a waveguide at which the polarization returns to its original value is referred to as a beat length.

The beat length is matched through an additional optimum process by adjusting the effective lengths of two planar waveguides at transmission/reception units using temperature controlling. In particular, a small birefringence results in a great beat length, which is inverse of birefringence. Accordingly, the beat length is not effectively matched with only the effective length adjustment through temperature controlling, thereby causing a significant difficulty in matching the polarization of beam.

### SUMMARY

In one aspect, there are provided an optical delay interferometer independent of the polarization state of input beams and an optical delay interferometer structure capable of outputting beams having the same polarization, thereby removing the polarization dependency of an optical delay interferometer and a polarization mismatch of a time-division optical interferometer (TDI) due to the birefringence characteristics of a planar optical waveguide.

In one general aspect, there is provided a reflective type optical delay interferometer apparatus including a coupler, a first optical waveguide, a second optical waveguide, a first polarization rotation reflection device and a second polarization rotation reflection device. The coupler is configured to divide an input optical signal into two optical signals. The first optical waveguide is configured to be connected to the coupler and have a first optical delay path to transmit a first optical signal corresponding to one of the two optical signals. The second optical waveguide is configured to be connected to the coupler, transmit a second optical signal corresponding to another of the two optical signals and have an optical delay path which is asymmetrical to the first optical delay path. The first polarization rotation reflection device is connected to the first optical waveguide. The second polarization reflection device is connected to the second optical waveguide. The first polarization rotation reflection device reflects the first optical signal and rotates a polarization of the first optical signal and a polarization of the reflected first optical signal. The second polarization rotation reflection device reflects the second optical signal and rotates a polarization of the second optical signal and a polarization of the reflected second optical signal.

In another general aspect, there is provided a reflective type optical delay interferometer apparatus including a coupler, a first optical waveguide, a second optical waveguide, and a polarization rotation reflection device. The coupler is configured to divide an input optical signal into two optical signals. The first optical waveguide is configured to be connected to the coupler and have a first optical delay path to transmit a first optical signal corresponding to one of the two optical signals. The second optical waveguide is configured to be connected to the coupler, transmit a second optical signal corresponding to another of the two optical signals and have an optical delay path which is asymmetrical to the first optical delay path. The polarization rotation reflection device is connected to the first optical waveguide and the second optical waveguide. The polarization rotation reflection device reflects the first optical signal and the second optical signal, rotates a polarization of the first optical signal and a polarization of the reflected first optical signal and rotates a polarization of the second optical signal and a polarization of the reflected second optical signal.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 shows an example of a transmission spectrum of an asymmetric optical interferometer.

FIG. 2 shows the configuration of an example of a reflective type optical delay interferometer.

FIG. 3 shows the configuration of another example of a reflective type optical delay interferometer.

FIGS. 4A to 4E show a coupler that is used for an example of a reflective type optical delay interferometer.

FIGS. 5A to 5C show examples of a connecting structure used to perform a beam coupling with a polarization rotation reflection device.

FIG. 6A shows the configuration of an example of a polarization rotation reflection device included in the reflective type optical delay interferometer shown in FIG. 2.

FIG. 6B shows the configuration of another example of a polarization rotation reflection device included in the reflective type optical delay interferometer shown in FIG. 2.

FIG. 6C shows the configuration of another example of a polarization rotation reflection device included in the reflective type optical delay interferometer shown in FIG. 3.

FIG. 7 shows the configuration of an example of a reflective type optical delay interferometer having an extended long path.

FIGS. 8A to 8D show the configurations of examples of a long path waveguide of an example of a reflective type optical delay interferometer.

FIGS. 9A and 9B show the configurations of examples of a reflective type optical delay interferometer including an example of a long path waveguide and a single polarization rotation reflection device.

FIG. 10 shows a phase modulation based quantum key distribution (QKD) system that employs the reflection type optical delay interferometer shown in FIG. 7.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

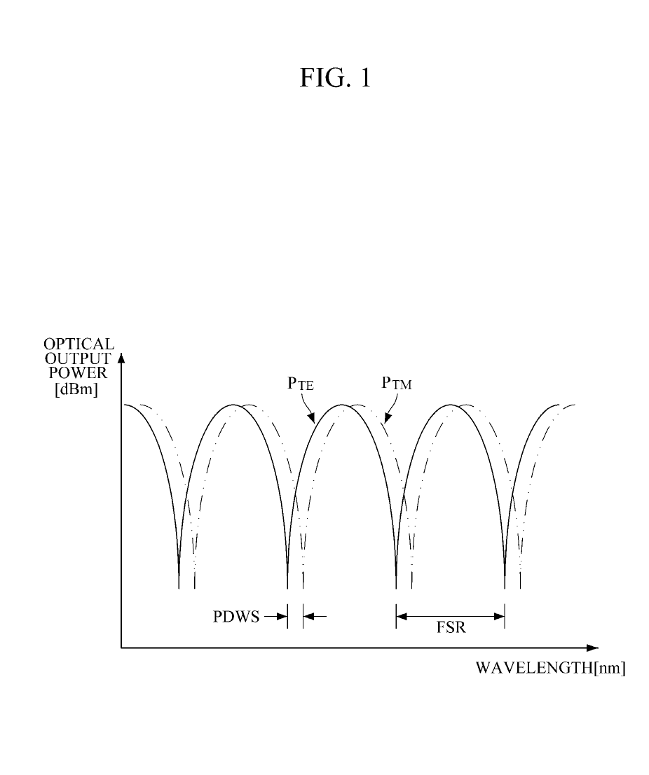

FIG. 1 shows an example of a transmission spectrum of an asymmetric optical interferometer.

If an asymmetric interferometer, such as an optical delay interferometer or an optical interleaver is configured by use of a planar waveguide, a transmission spectrum periodically changes. In addition, a polarization dependent wavelength shift (PDWS) occurs at a transmission spectrum due to the birefringence characteristics as shown in FIG. 1. Such an asymmetric optical interferometer formed using a planar waveguide produces a predetermined light interference tendency which varies depending on the direction of polarization as shown in equation 1 below.

$${P}_{TE} ∝ [ 1 + cos ( \frac{2 {n}_{TE} π}{λ} Δ l ) ] \\ {P}_{TM} ∝ [ 1 + cos ( \frac{2 {n}_{TM} π}{λ} Δ l ) ] \qquad [ Equation 1 ]$$

Herein, P_{TE} represents an optical output of a Transverse Electric (TE) mode polarization, and P_{TM} represents an optical output of a Transverse Magnetic (TM) mode polarization. n_{TE} and n_{TM} represent the indices of refraction for the TE mode polarization and the TM mode polarization, respectively, Δl is the difference in length between two paths of an asymmetric interferometer, and λ is a wavelength of light passing through a waveguide. The difference in refractive indices n_{TE} and n_{TM} is related by the birefringence B, that is, B=|n_{TE}−n_{TM}|.

As described above, the birefringence characteristics of a waveguide causes a mismatch of nulls of an interference spectrum between a TE polarization beam and a TM polarization beam. In general, PDWS makes an effective bandwidth to be narrower. If the PDWS occurs as much as several percents (%) with respect to a free spectral range (FSR) of an interference spectrum, the characteristics of devices are degraded. In particular, an asymmetric path of a delay interferometer has a greater difference in length compared to an interleaver, causing a very narrow FSR. Accordingly, the delay interferometer is more susceptible to the PDWS phenomenon.

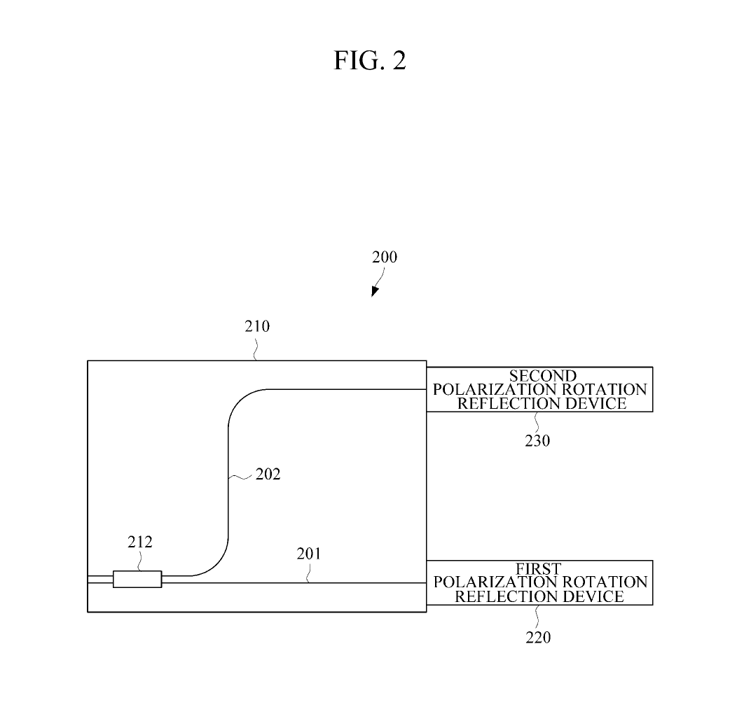

FIG. 2 shows the configuration of an example of a reflective type optical delay interferometer.

A reflective type optical delay interferometer 200 includes an asymmetric delay device 210 based on a planar waveguide and polarization rotation reflection devices 220 and 230.

The asymmetric delay device 210 includes a coupler 212, a first optical waveguide 201 and a second optical waveguide 202. The first optical waveguide 201 and the second optical waveguide 202 form an asymmetric optical delay path.

The coupler 212 divides an input optical signal (or a beam) into two optical signals.

The first optical waveguide 201 is connected to the coupler 212 and has a first optical delay path to transmit a first optical signal corresponding to one of the divided two optical signals.

The second optical waveguide 202 is connected to the coupler 212, transmits a second optical signal corresponding to another of the divided two optical signals, and has an optical delay path that is asymmetric to the first optical delay path.

The polarization rotation reflection devices 220 and 230 include a first polarization rotation device 220 and a second polarization rotation device 230.

The first polarization rotation reflection device 220 is connected to the first optical waveguide 201. The second polarization rotation reflection device 230 is connected to the second optical waveguide 202. The first polarization rotation reflection device 220 has the same structure as that of the second polarization rotation reflection device 230.

The first polarization rotation reflection device 220 and the second polarization rotation reflection device 230 are configured to reflect input optical signals and rotate polarizations of the input optical signals and the reflected optical signals. That is, the first polarization rotation reflection device 220 reflects the first optical signal and rotates a polarization of the first optical signal and a polarization of the reflected first optical signal. The second polarization rotation reflection device 230 reflects the second optical signal and rotates a polarization of the second optical signal and a polarization of the reflected second optical signal.

Hereinafter, the description will be made in relation to the first polarization rotation reflection device 220.

The first polarization rotation reflection device 220 includes a polarization rotation optical device producing Faraday effect and a reflection component such as a mirror.

The first polarization rotation reflection device 220 is configured to rotate each of the polarization of the first optical signal and the polarization of the reflected first optical signal with respect to their polarization axes by an angle of 45 degrees only in one direction regardless of a traveling direction of the first optical signal. The first optical signal experiences a total polarization rotation of 90 degrees while traveling back and forth through a reflection component. For example, a TE mode beam is converted to a TM mode and then reflected. In this configuration, the birefringence caused by the first optical waveguide is canceled out.

That is, an optical signal (or a beam) is divided at the coupler 212 provided at an input port and the divided signals travel along an asymmetric path. The divided optical signals are subject to a rotation of 90 degrees and reflection at the first polarization rotation reflection device 220 and the second polarization rotation reflection device 230. Thereafter, the optical signals travel by passing through the coupler 212 via the same delay optical path and then output.

The above configuration of the first polarization rotation reflection device 220 is expressed through the Jones matrix shown in equation 2. That is, equation 2 represents a configuration in which the input optical signal is reflected and each of the polarization of the first optical signal and the polarization of the reflected first optical signal is rotated with respect to their polarization axes by an angle of 45 degrees only in one direction regardless of a traveling direction of the first optical signal. The Jones matrix shown in equation 2 is referred to as a faraday mirror (FM) Jones matrix.

$$\begin{matrix}FM = R ( - 45 ° ) \cdot M \cdot R ( 45 ° ) \\ = \frac{1}{\sqrt{2}} ( \begin{matrix}1 & 1 \\ - 1 & 1\end{matrix} ) ( \begin{matrix}1 & 0 \\ 0 & - 1\end{matrix} ) \frac{1}{\sqrt{2}} ( \begin{matrix}1 & - 1 \\ 1 & 1\end{matrix} ) \\ = ( \begin{matrix}0 & - 1 \\ - 1 & 0\end{matrix} )\end{matrix} \qquad [ Equation 2 ]$$

Herein, R(45° represents a matrix value of a polarization rotation device that rotates the polarization of an input optical signal by an angle of 45 degrees in a clock wise direction with respect to an axis corresponding to the input direction of the input optical signal. R(−45° represents a matrix value of a polarization rotation device that rotates the polarization of a reflected optical signal by an angle of −45 degrees in a clockwise direction with respect to an axis corresponding to the output direction of the reflected optical signal, that is, a clockwise rotation of 45 degrees with respect to an axis corresponding to the input direction. M represents a matrix value of a reflection component such as a mirror. Herein, the negative sign (−) of Faraday mirror (FM) in equation 2 represents that the traveling direction of the optical signal is reversed.

When an optical signal is input to a waveguide with a polarization rotation reflection device applied thereto, an output optical signal (Aₒᵤₜ₁) passing through a short path of the asymmetric path and an output optical signal (Aₒᵤₜ₂) passing through a long path of the asymmetric path are represented as equation 3 below.

Aₒᵤₜ₁=W(l₁)·FM·W(l₁)·Aᵢₙ

Aₒᵤₜ₂=W(l₂)·FM·W(l₂)·Aᵢₙ [Equation 31]

Herein, W represents a propagation matrix of a waveguide, and FM represents the Jones is Matrix of equation 2. l₁ and l₂ represent the lengths of the short path and the long path, respectively. In addition, Aᵢₙ represents an input optical signal and Aₒᵤₜ represents an output optical signal that is output after passing the reflective type optical delay interferometer 200. The propagation matrix (W) and the Jones matrix (FM) are applied to equation 3, producing equation 4.

$${A}_{out 1} = - exp ( i \frac{( {n}_{TE} + {n}_{TM} ) π}{λ} {l}_{1} ) \cdot {A}_{in} \\ {A}_{out 2} = - exp ( i \frac{( {n}_{TE} + {n}_{TM} ) π}{λ} {l}_{2} ) \cdot {A}_{in} \qquad [ Equation 4 ]$$

When considering Equation 4, if two output optical signals interfere, n_{TE} and n_{TM} are averaged each other and the birefringence characteristics are canceled output. Accordingly, an interference spectrum having no PDWS is obtained.

According to a conventional method suggested as a solution for the PDWS, a half wave plate is inserted in the middle of an asymmetric path of a waveguide such that a polarization of an input beam is rotated and thus the polarization dependency due to the birefringence is canceled. In this case, the optical axis of the half wave plate needs to be adjusted to be tilted with an angle of 45 degrees or −45 degrees to the optical axis of the TE mode or the TM mode. To this end, the half wave plate needs to be inserted while maintaining an angle of 45° without a small deviation. In addition, the path of the waveguide needs to have the same length and the same optical characteristics, such as birefringence, before and after the half waveguide plate.

According to the above described polarization rotation device, the amount of rotation of a polarization is dependent of a manufacturing technology, and can be adjusted with a high degree of precision. However, aligning the optical axis of the half waveguide plate requires a complicating optical alignment process, causing a difficulty in maintaining a high degree of precision. In addition, the rotation of a polarization through the polarization rotation device is independent of the polarization direction of an input beam, and thus the complicating process of aligning an optical axis is not required.

The above described reflective type optical delay interferometer is configured to adopt a reflective waveguide structure such that an input beam travels back and forth in the same path, and rotate a polarization of the beam at the same time of reflecting, thereby canceling the birefringence effect. In this configuration, an input optical signal travels back and forth through the same path of the waveguide in the course of reflection, resulting in the automatic match of the waveguide related optical characteristics, for example, the length of the path. In addition, this example uses a Faraday mirror that is independent of a polarization of an input beam, that is, not having optical axis characteristics to reflect optical signals, so there is no need for an optical axis alignment.

That is, according to the example of the configuration of the optical delay interferometer adopting a reflection structure, the birefringence effect of a waveguide is automatically compensated, thereby effectively mitigating the PDWS effect and obtaining some qualities that are not related to an optical axis of an input beam.

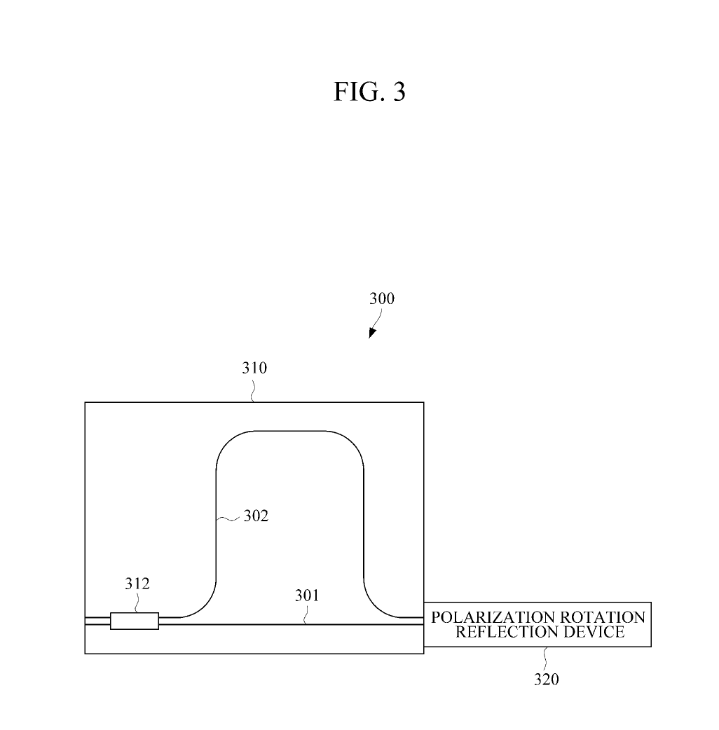

FIG. 3 shows the configuration of another example of a reflective type optical delay interferometer.

A reflective type optical delay interferometer 300 includes a planar waveguide based asymmetric delay device 310 and a polarization rotation reflection device 320.

The asymmetric delay device 310 includes a coupler 312, a first optical waveguide 301 and a second optical waveguide 302. The first optical waveguide 301 and the second optical waveguide 302 form an asymmetric optical delay path. The asymmetric delay device 310 has the similar configuration as that of the asymmetric delay device 210 shown in FIG. 1.

The coupler 312 divides an input optical signal into two optical signals. The first optical waveguide 301 is connected to the coupler 312 and has a first optical delay path configured to transmit a first optical signal corresponding to one optical signal of the divided two optical signals. The second optical waveguide 302 is connected to the coupler 312, transmits a second optical signal corresponding to another optical signal of the divided two optical signals and has an optical delay path that is asymmetric to the first optical delay path.

The reflective type optical delay interferometer 300 is different from the reflective type optical delay interferometer 200 shown in FIG. 2 in that an output port of the first optical waveguide 301 and an output port of the second optical waveguide 302 are disposed adjacent to each other and coupled to each other through a single polarization rotation reflection device 320. This configuration prevents the performance degradation that may be caused by a characteristic difference between the two polarization rotation reflection devices shown in the reflective type optical delay interferometer 200.

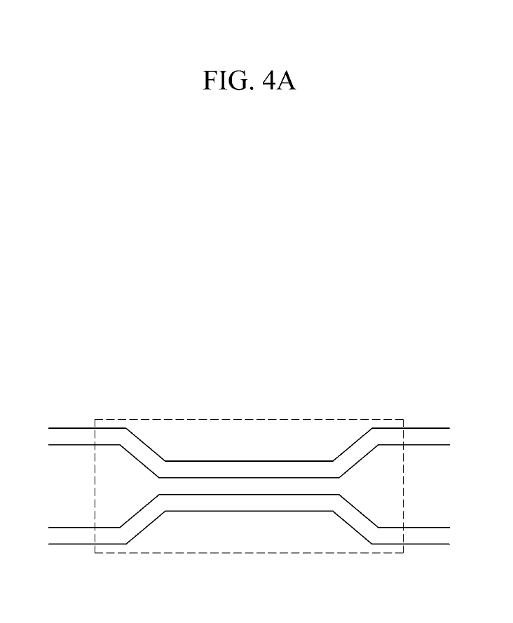

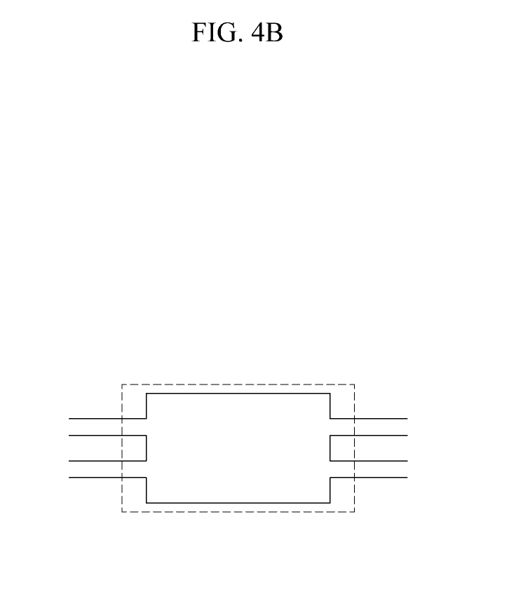

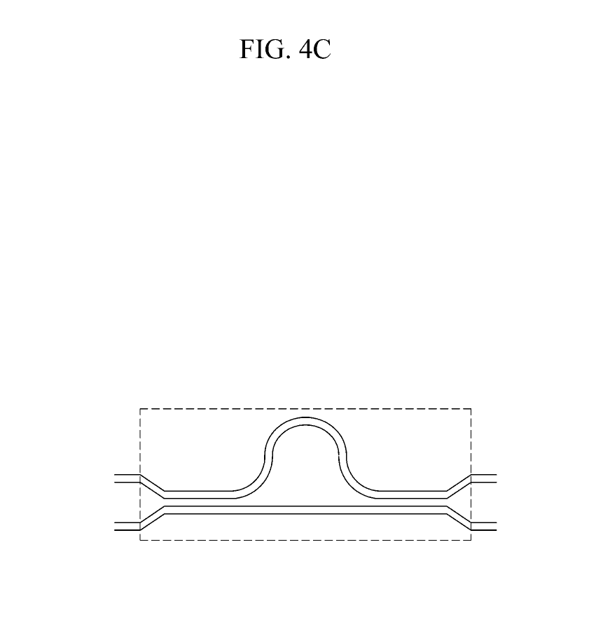

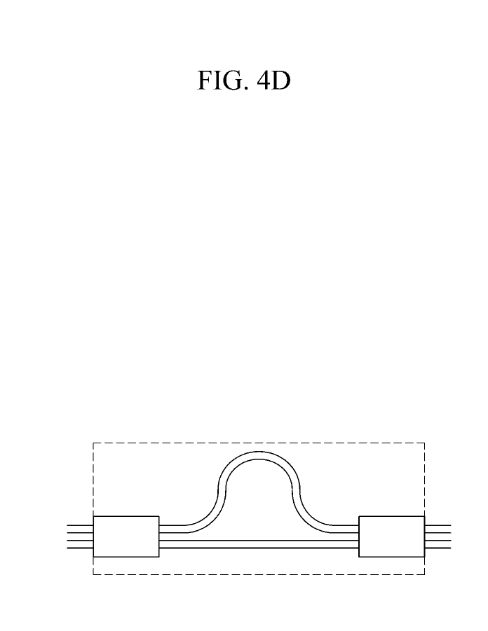

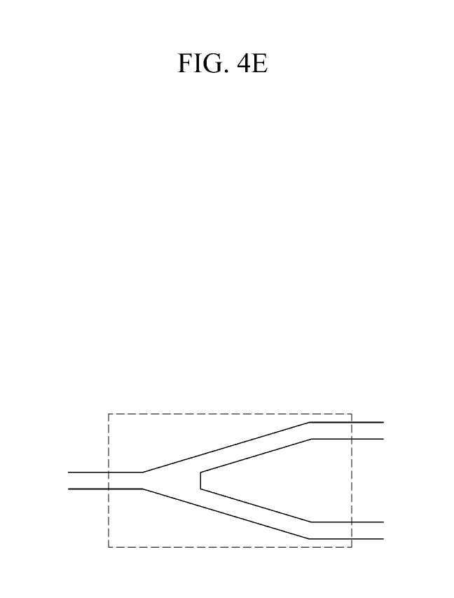

FIGS. 4A to 4E show a coupler that is used for an example of a reflective type optical delay interferometer.

The coupler 212 of the reflective type optical delay interferometer 200 shown in FIG. 2 and the coupler 312 of the reflective type optical delay interferometer 300 shown in FIG. 3 are each implemented using a general directional coupler shown in FIG. 4A.

Alternative, the coupler 212 and the coupler 312 may be implemented using various types of couplers, for example, a Multi-Mode Interference coupler shown in FIG. 4B, a Wide-band coupler shown in FIG. 4C having a wavelength band extended, a Wide-band coupler shown in FIG. 4D adopting a Multi-Mode Interference coupler, and a Y-branch shaped optical output splitter shown in FIG. 4E having no phase change. The examples of the coupler shown in FIGS. 4A to 4E are implemented in the form of an asymmetric coupler that adjusts an output power ratio to compensate for an optical loss on an asymmetric optical path.

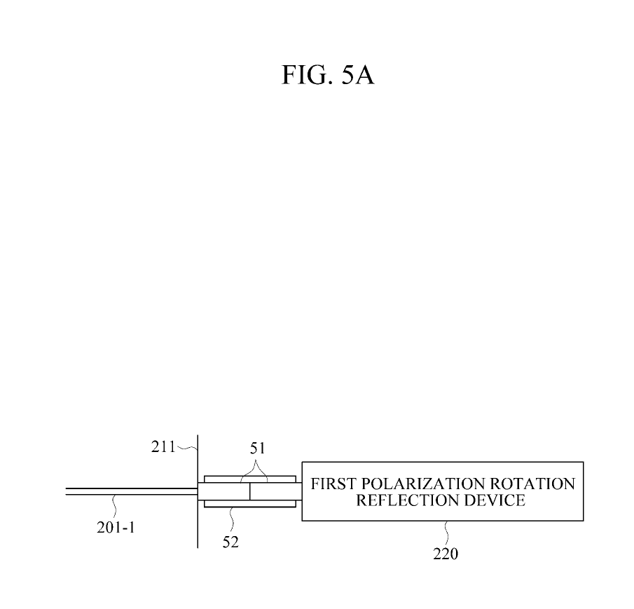

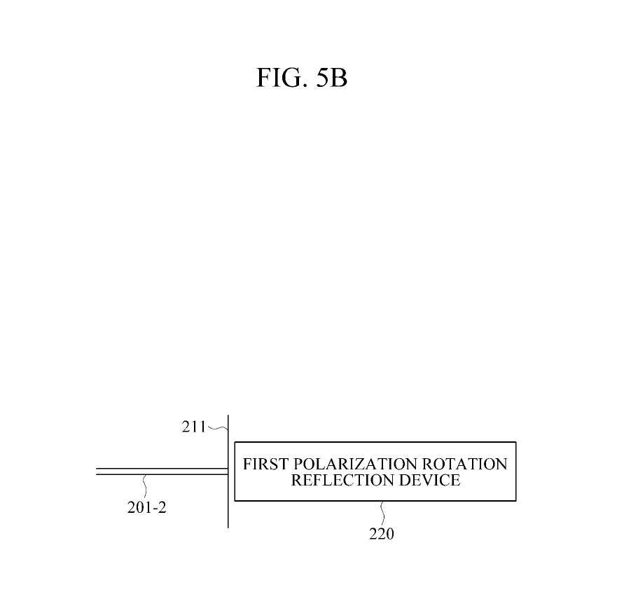

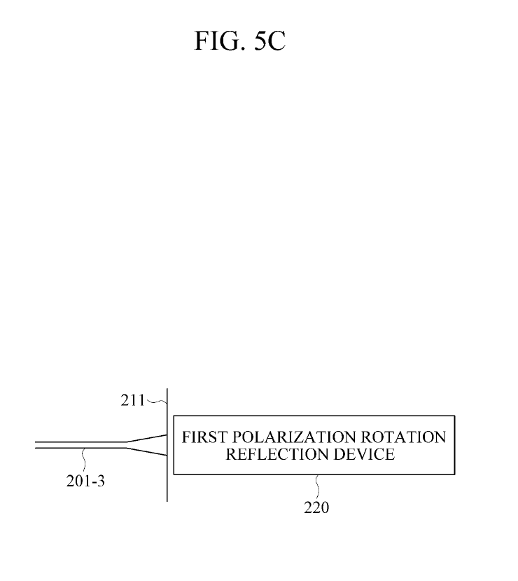

FIGS. 5A to 5C show examples of a connecting structure used to perform a beam coupling with a polarization rotation reflection device.

FIGS. 5A to 5C show a connecting structure between a cross section 211 of the asymmetric delay device 210 and the first polarization rotation reflection device 220. As shown in FIG. 5A, the cross section 211 of the asymmetric delay device 210 may be connected to the first polarization rotation reflection device 220 through a ferrule connecting structure including a general ferrule 51 and a sleeve 52. As shown in FIG. 5B, the cross section 211 of the asymmetric delay device 210 may be connected to the first polarization rotation reflection device 220 through a simple type butt coupling. As shown in FIG. 5C, the cross section 211 of the asymmetric delay device 210 may be connected to the first polarization rotation reflection device 220 through a butt coupling using a waveguide with a taper structure preventing beam distribution.

For convenience sake, the description of the examples of a connecting structures throughout FIGS. 5A to 5C is made in relation to connecting the cross section 211 of the asymmetric delay device 210 to the first polarization rotation reflection device 220. However, these examples may be used to connect the asymmetric delay device 210 to the second polarization rotation reflection device 230, or to connect the asymmetric delay device 310 to the polarization rotation reflection device 320.

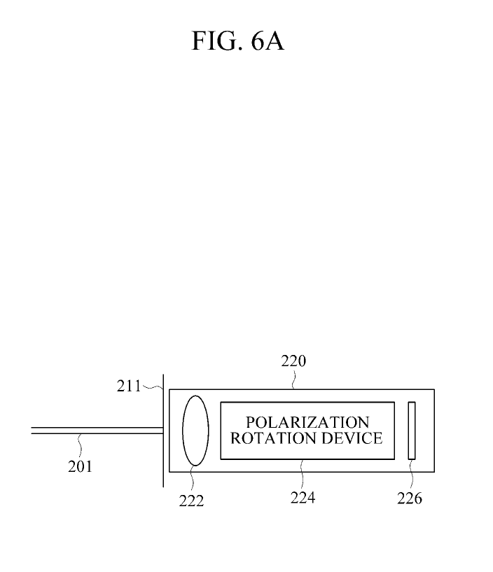

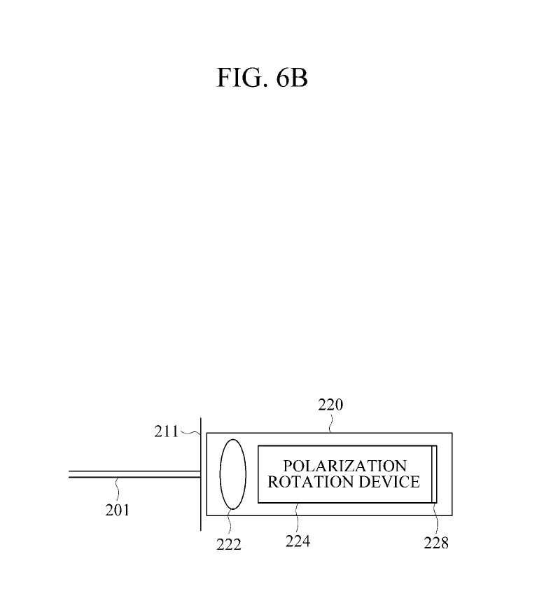

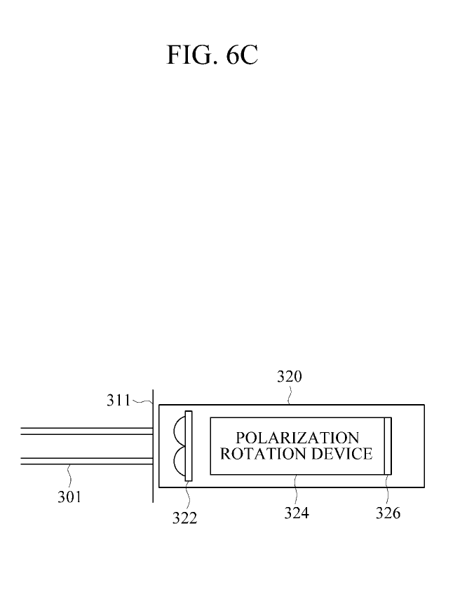

FIG. 6A shows the configuration of an example of the first polarization rotation reflection device 220 included in the reflective type optical delay interferometer 200 shown in FIG. 2, FIG. 6B shows the configuration of another example of the first polarization rotation reflection device 220 included in the reflective type optical delay interferometer 200 shown in FIG. 2, and FIG. 6C shows the configuration of another example of the polarization rotation reflection device 320 included in the reflective type optical delay interferometer shown 300 in FIG. 3.

As shown in FIG. 6A, the first polarization rotation reflection device 220 of FIG. 2 may include a lens 222, a polarization rotation device 224 and a mirror 226.

The lens 222 represents a collimation lens allowing an input first signal to travel in parallel. The polarization rotation device 224 rotates a polarization of the input first optical signal by an angle of 45 with respect to a polarization axis only in one direction regardless of a traveling direction of the first optical signal. The mirror 226 reflects the input first optical signal, which is introduced after passing through the polarization rotation device 224. The first optical signal reflected from the mirror 226 is again subject to a rotation of polarization by an angle of 45 degrees through the polarization rotation device 224 and is output through the same waveguide as the waveguide through which the first optical signal has been input.

As shown in FIG. 6B, the first polarization rotation reflection device 220 of FIG. 2 may include a lens 222, a polarization rotation device 224 and a reflection coating film 228 corresponding to the mirror 226 of FIG. 6A. The reflection coating film 228 may be integrated with the polarization rotation device 224.

The lens 222 and the polarization rotation device 224 of FIG. 6B have the same functions of the lens 222 and the polarization rotation device 224 of the FIG. 6A. The second polarization rotation device 230 of FIG. 2 may have the same configuration of the first polarization rotation device 220 shown in FIG. 6A or 6B.

As shown in FIG. 6C, the polarization rotation reflection device 320 of FIG. 3 may include a lens array 322, a polarization rotation device 324 and a mirror 326.

The lens array 322 allows the first optical signal and the second optical signal, which are divided by the coupler 312, to travel in parallel. Similar to the polarization rotation device 224, the polarization rotation device 324 rotates a polarization of the two optical signals, which have passed through the lens array 322, with respect to a polarization axis by an angle of 45 degrees only in one direction regardless of a traveling direction of the optical signals. Similar to the mirror 226, the mirror 326 reflects the two optical signals, which have passed through the polarization rotation device 324. The mirror 326 may be replaced with a reflection coating film as shown in FIG. 6B. The two optical signals reflected from the mirror 326 are again subject to a rotation of polarization by an angle of 45 degrees through the polarization rotation device 324 and then output through the same waveguide as the waveguide through which the two optical signal have been input.

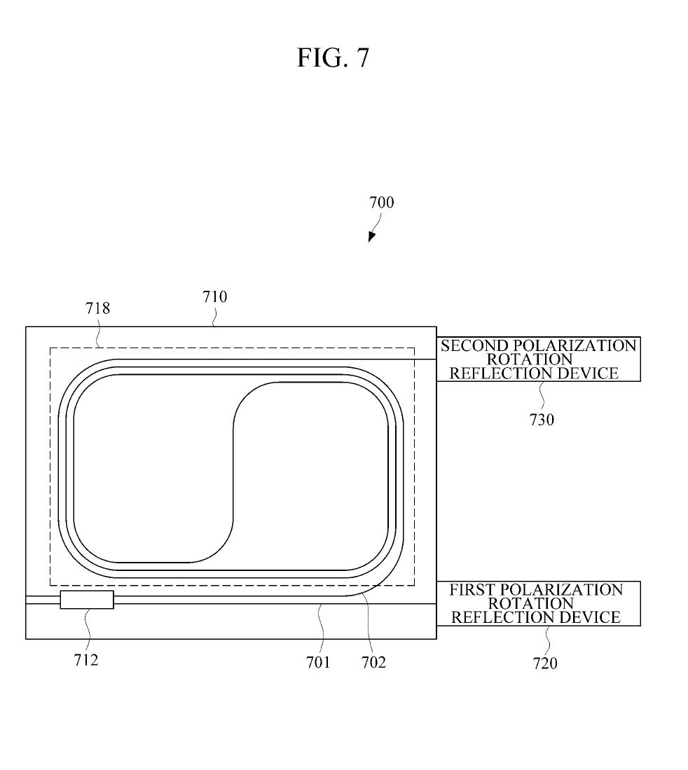

FIG. 7 shows the configuration of an example of a reflective type optical delay interferometer having an extended long path.

A reflective type optical delay interferometer 700 having an extended long path shown in FIG. 7 may be applied to a phase modulation based quantum key distribution (QKD) system.

The reflective type optical delay interferometer 700 includes a planar waveguide based asymmetric delay device 710, a first polarization rotation reflection device 720 and a second polarization rotation reflection device 730. The asymmetric delay device 710 includes a coupler 712, a temperature controlling device 718, a first waveguide 701 and a second waveguide 702.

The reflective type optical delay interferometer 700 has the same configuration as the reflective type optical delay interferometer 200 of FIG. 2 except for the second waveguide 702 and the temperature controlling device 718, in which the second waveguide 702 has a length longer than that of the second waveguide 202 of the reflective optical delay interferometer 200 in FIG. 2 and the temperature controlling device 718 is additionally installed.

Since a quantum key distribution (QKD) system produces an optical pulse having a time difference of about several nano seconds by an asymmetric optical delay path, the long path has a length of about several tens of centimeters. Accordingly, as shown in FIG. 7, the path needs to be extended by increasing the turning rounds of the path. Since the extension of the path increases the instability factor affected by temperature change, the temperature controlling device 718 such as a heater may be added as shown in FIG. 7.

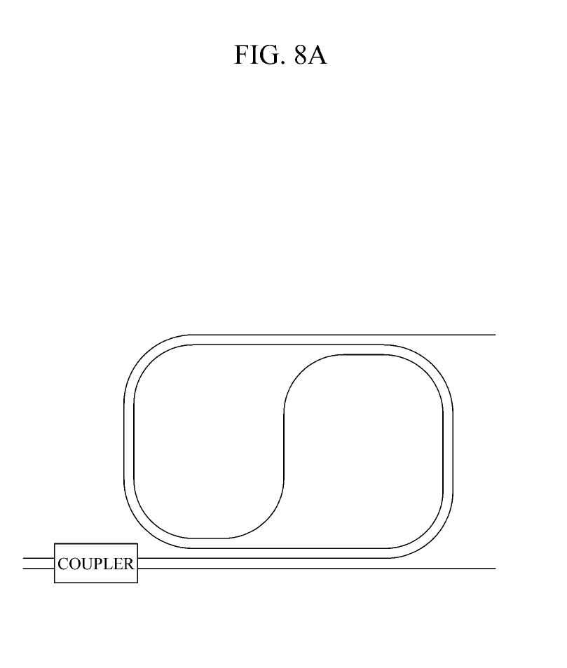

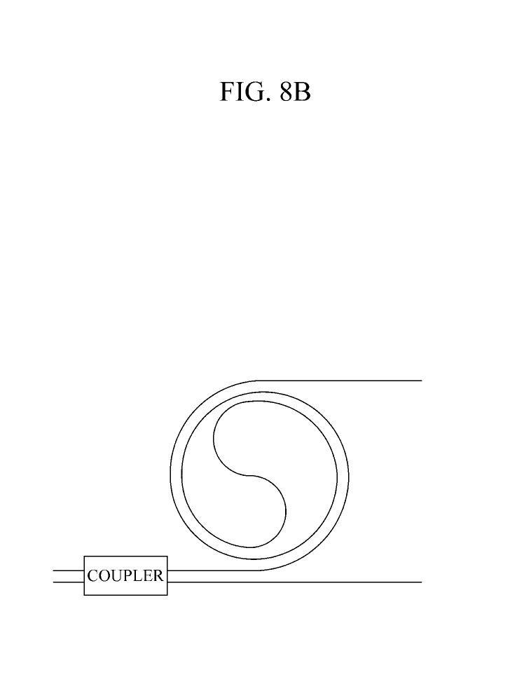

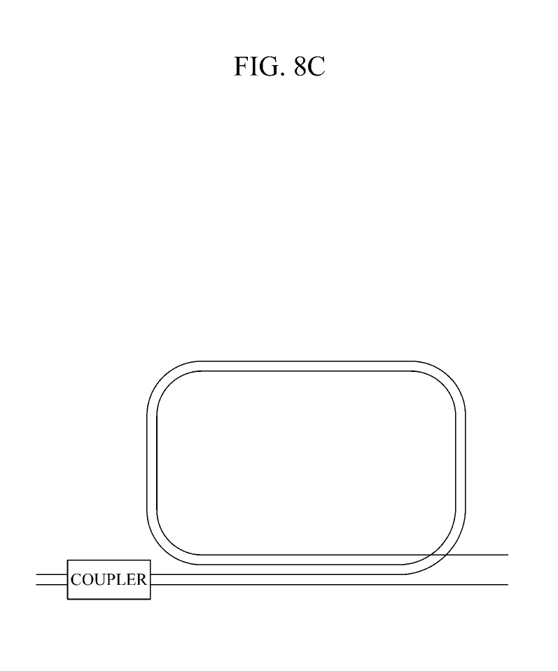

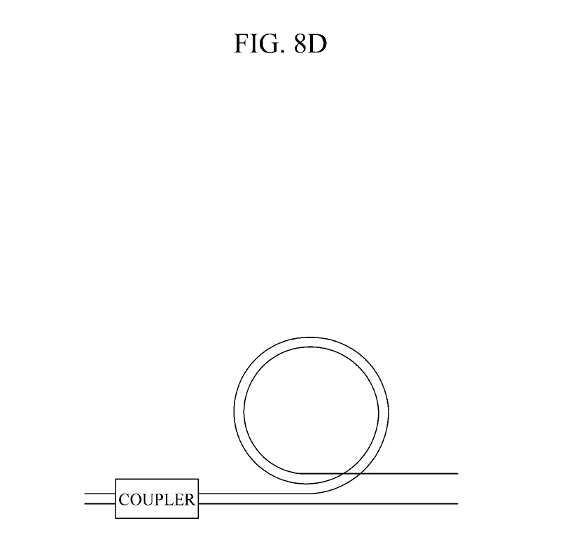

FIGS. 8A to 8D show the configurations of examples of a long path waveguide of an example of a reflective type optical delay interferometer.

The waveguides 701 and 702 of FIG. 7 may be implemented in various forms as shown throughout FIGS. 8A to 8D. For the second waveguide 702 to form a long path, the first waveguide 701 and the second waveguide 702 may be provided in a rectangular spiral structure having rounded corners as shown in FIG. 8A. The first waveguide 701 and the second waveguide 702 may be provided in a circular spiral structure as shown in FIG. 8B. In addition, the first waveguide 701 and the second waveguide 702 may be provided in a rectangular pass-crossing structure as shown in FIG. 8C or a circular path-crossing structure as shown in FIG. 8D, in which a path crossing is made on the second waveguide 702. The rectangular path-crossing structure of FIG. 8C and the circular path-crossing structure of FIG. 8D may be implemented in the form of a reflective type optical delay interferometer including a single polarization rotation reflection device as shown in FIG. 3 and an extended long path that is suitable for a quantum key distribution (QKD) system.

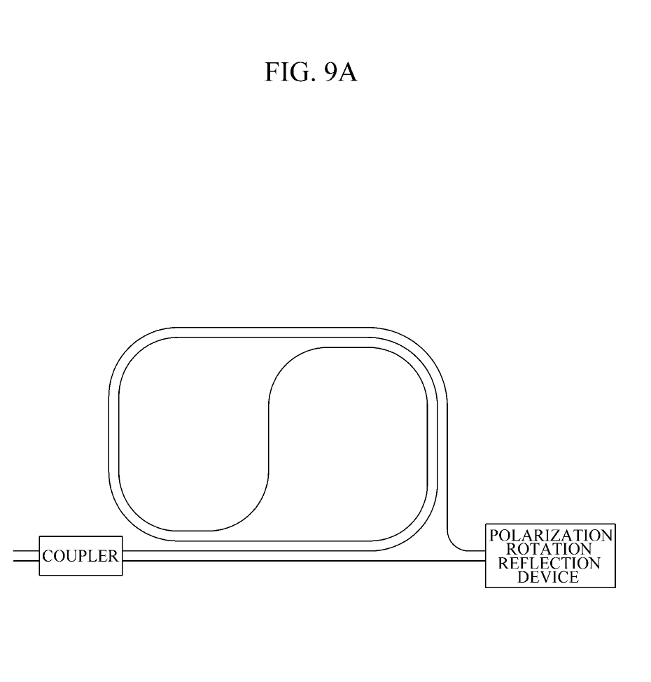

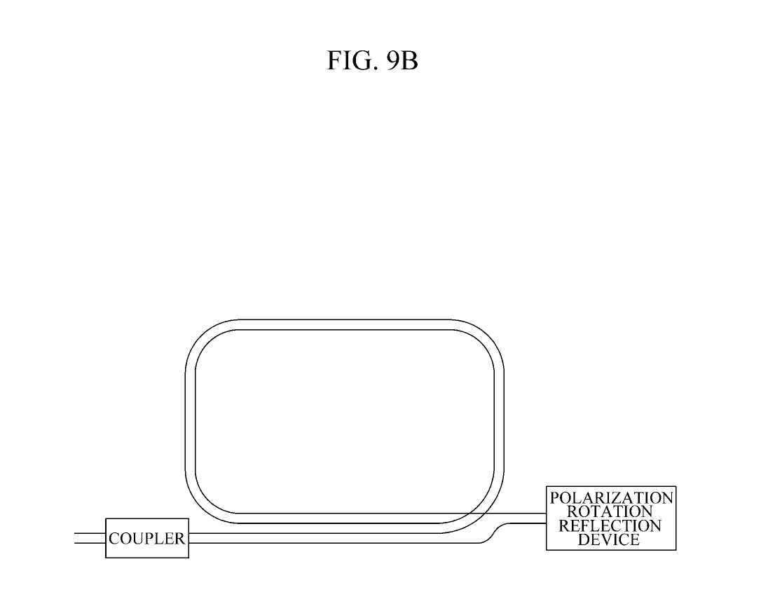

FIGS. 9A and 9B show the configurations of examples of a reflective type optical delay interferometer including a long path waveguide and a single polarization rotation reflection device.

As shown in FIGS. 9A and 9B, the examples of a reflective type optical delay interferometer have two waveguides disposed adjacent to each other at an output port of waveguides and a single polarization rotation reflection device. That is, the examples of a reflective type optical delay interferometer is implemented by modifying the structure of FIG. 7 using the structure of FIG. 3 that is suggested to prevent the performance degradation due to the characteristic difference between two polarization rotation reflection devices at output ports connecting the asymmetric delay device 710 to the polarization rotation reflection devices 720 and 730.

The asymmetric delay device, the polarization rotation reflection device and the coupler for coupling between the asymmetric delay device and the polarization rotation reflection device have the same structures as those above described. Accordingly, the detailed descriptions thereof will be omitted.

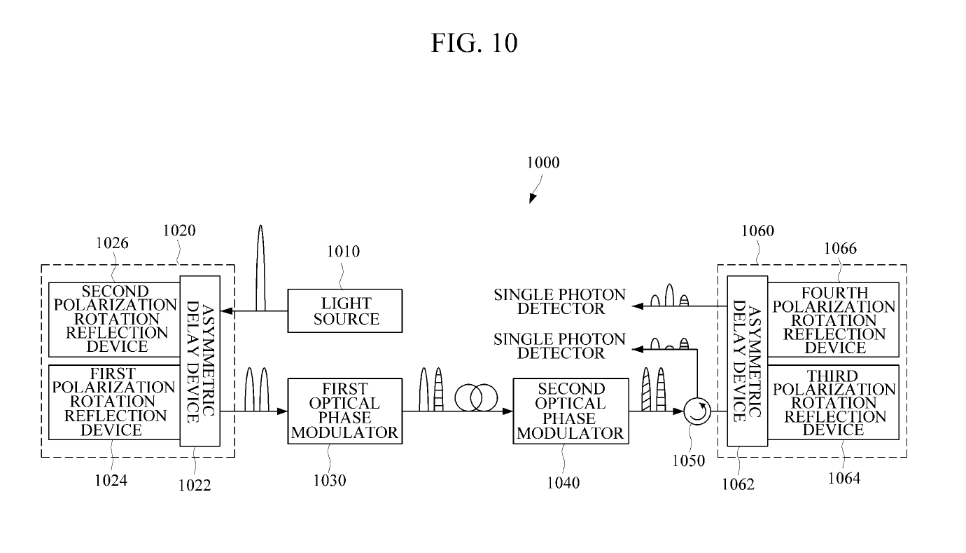

FIG. 10 shows a phase modulation based quantum key distribution (QKD) system that employs the reflection type optical delay interferometer shown in FIG. 7.

A quantum key distribution (QKD) system 1000 has a transmission unit and a reception unit connected to each other through a quantum channel or an optical fiber, and uses BB84 protocol. The transmission unit of the QKD system 1000 includes a light source 1010, a time division optical interferometer 1020 and a first optical phase modulator 1030. The reception unit of the QKD system 1000 includes a second optical phase modulator 1040, a photo circulator 1050 and a time division optical interferometer 1060.

The time division optical interferometer 1020 and the time division optical interferometer 1060 are disposed on the transmission unit and the reception unit, respectively, and operate in pairs. The time division optical interferometer 1020 includes an asymmetric delay device 1022, a first polarization rotation reflection device 1024 and a second polarization rotation reflection device 1026. The time division optical interferometer 1060 includes an asymmetric delay device 1062, a third polarization rotation reflection device 1064 and a fourth polarization rotation reflection device 1066. Each of the time division optical interferometer 1020 and the time division optical interferometer 1060 has the same structure as that of the optical delay interferometer 700 of FIG. 7. The time division optical interferometers 1020 and 1060 may have the same structure as that shown in FIG. 9A or FIG. 9B. Since the optical pulses are subject to a time division at the transmission unit and the reception unit and contribute to interference, the optical delay interferometer 700 is referred to as a time division optical interferometer.

The time division optical interferometer 1020 of the transmission unit divides an input pulse signal into two optical pulse signals, applies an asymmetric time delay to the optical pulse signals and outputs the optical pulses signals having been subject to an asymmetric time delay. The optical pulse signals having been divided at the time division optical interferometer 1020 of the transmission unit are again subject to a time division at the time division optical interferometer 1060 of the reception unit.

The asymmetric delay device 1022 of the time division optical interference 1020 of the transmission unit applies the same amount of time delay as that applied by the asymmetric delay device 1062 of the time division optical interferometer 1060 of the reception unit. Accordingly, two of the divided four optical pulses overlap and interfere each other at an output port of the asymmetric delay device 1062 of the reception unit.

In the QKD system 1000, the first optical phase modulator 1030 of the transmission unit performs a phase modulation on an optical pulse signal of the two optical pulse signals having been subject to the time division, thereby transmitting code key information. The second optical phase modulator 1040 of the reception unit performs a phase modulation on the other optical pulse signal of the two optical pulse signals having been subject to the time division to decode a code key signal. As a result, an output signal of the time division optical interferometer 1060 of the reception unit obtains an optical interference signal having an intensity varying each time. By analyzing the optical interference signal having a time variant intensity, the quantum code key information is extracted. In order to enhance the efficiency of signal detection at the reception unit, the time division optical interferometer 1060 is configured to output two signals having a high contrast and the signals are detected by use of two quantum detectors.

In order to improve the performance of the QKD system 100, it is necessary to ensure the interference performance of the time division optical interferometers 1020 and 1060. To this end, optical signals input to the time division interferometers 1020 and 1060 and optical signals output from the time division interferometers 1020 and 1060 need to have highly adjusted polarization and phase.

The performance of the time division optical interferometers 1020 and 1060 using asymmetric optical delay devices 1022 and 1062 is measured through a visibility expressed through equation 5 below, in which the visibility is related to a quantum bit-error-rate (QBER) that represents the performance of a quantum cryptography communication system.

$$V = \frac{{I}_{max} - {I}_{min}}{{I}_{max} + {I}_{min}} = 1 - 2 \cdot QBER \qquad [ Equation 5 ]$$

Herein, Iₘₐₓ and Iₘᵢₙ represent the intensities of optical output power at the maximum interference and the minimum interference, respectively. In order to obtain a high level of visibility in an optical interferometer, two beams need to have the same polarization and have a phase difference of an integer multiple of π.

A Mach-Zehnder interferometer based time division optical interferometer produces unstable phase and polarization of beams. In addition, a Michelson interferometer based time division optical interferometer produces polarization matched beams but fails to produce stable phases. A planar waveguide based Mach-Zehnder interferometer type time division optical interferometer achieves the phase stability but has a difficulty in matching polarization due to the birefringence. However, the example of the time division optical interferometers 1020 and 1060 achieves the phase stability and the polarization matching through canceling out the birefringence by adopting the structure of the reflective type optical delay interferometer 700 of FIG. 7 or one of the structures of the reflective type optical delay interferometers of FIGS. 9A and 9B. Accordingly, the performance of the QKD system is ensured.

As described above, as the example of the reflective type optical delay interferometer having an extended long path is applied to the QKD system, a phase stability corresponding to a characteristic of a planar waveguide is ensured. In addition, the birefringence is automatically canceled out through the reflective type structure and thus output beams can maintain the same state of polarization all the time. Accordingly, the interference performance of the QKD system is improved.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A reflective type optical delay interferometer apparatus comprising:
a coupler configured to divide an input optical signal into two optical signals;
a first optical waveguide configured to be connected to the coupler and have a first optical delay path to transmit a first optical signal corresponding to one of the two optical signals;
a second optical waveguide configured to be connected to the coupler, transmit a second optical signal corresponding to another of the two optical signals and have an optical delay path to which is asymmetrical to the first optical delay path;
a first polarization rotation reflection device connected to the first optical waveguide; and
a second polarization rotation reflection device connected to the second optical waveguide, wherein the first polarization rotation reflection device reflects the first optical signal and rotates a polarization of the first optical signal and a polarization of the reflected first optical is signal and the second polarization rotation reflection device reflects the second optical signal and rotates a polarization of the second optical signal and a polarization of the reflected second optical signal.

2. The reflective type optical delay interferometer apparatus of claim 1, wherein the first polarization rotation reflection device is configured to rotate each of the polarization of the first optical signal and the polarization of the reflected first optical signal by an angle of 45 degrees only in one direction regardless of a traveling direction of the first optical signal such that the first optical signal experiences a total polarization rotation of 90 degrees, and
the second polarization rotation reflection device is configured to rotate each of the polarization of the second optical signal and the polarization of the reflected second optical signal by an angle of 45 degrees only in one direction regardless of a traveling direction of the second optical signal such that the second optical signal experiences a total polarization rotation of 90 degrees.

3. The reflective type optical delay interferometer apparatus of claim 1, wherein the first polarization rotation reflection device comprises:
a lens configured to make the first optical signal to travel in parallel;
a polarization rotation device configured to rotate an polarization of the first optical signal by an angle of 45 degrees only in one direction regardless of a traveling direction of the to first optical signal; and
a mirror configured to reflect the first optical signal having passed through the polarization rotation device, wherein
the second polarization rotation reflection device comprises:
a lens configured to make the second optical signal to travel in parallel;
a polarization rotation device configured to rotate a polarization of the second optical signal by an angle of 45 degrees only in one direction regardless of a traveling direction of the second optical signal; and
a mirror configured to reflect the second optical signal having passed through the polarization rotation device.

4. The reflective type optical delay interferometer apparatus of claim 1, wherein the first polarization rotation reflection device comprises:
a lens configured to make the first optical signal to travel in parallel;
a polarization rotation device configured to rotate a polarization of the first optical signal by an angle of 45 degrees only in one direction regardless of a traveling direction of the first optical signal; and
a reflection coating film configured to reflect the first optical signal having passed through the polarization rotation device, wherein
the second polarization rotation reflection device comprises:
a lens configured to make the second optical signal to travel in parallel;
a polarization rotation device configured to rotate a polarization of the second optical signal by an angle of 45 degrees only in one direction regardless of a traveling direction of the to second optical signal; and
a reflection coating film configured to reflect the second optical signal having passed through the polarization rotation device.

5. The reflective type optical delay interferometer apparatus of claim 1, wherein is the second waveguide has a path longer than a path of the first waveguide and is provided in a spiral shape.

6. The reflective type optical delay interferometer apparatus of claim 5, wherein the second waveguide is provided in a form of a rectangular having rounded corners or provided in a circular spiral.

7. The reflective type optical delay interferometer apparatus of claim 1, wherein the coupler is implemented using one of a directional coupler, a multiple mode interference coupler, a wide-band coupler, a wide-band coupler employing a multiple mode interference coupler and a Y-branch shaped optical output splitter.

8. The reflective type optical delay interferometer apparatus of claim 1, wherein the first optical waveguide is connected to the first polarization rotation reflection device and the second optical waveguide is connected to the second polarization rotation reflection device by use of a ferrule coupling, a butt coupling and a butt coupling using a taper structure waveguide.

9. The reflexive type optical delay interferometer apparatus of claim 1, wherein the reflective type optical delay interferometer apparatus is a time division optical interferometer a transmission unit and a reception unit included in a quantum key distribution (QKD) system.

10. A reflective type optical delay interferometer apparatus comprising:
a coupler configured to divide an input optical signal into two optical signals;
a first optical waveguide configured to be connected to the coupler and have a first optical delay path to transmit a first optical signal corresponding to one of the two optical is signals;
a second optical waveguide configured to be connected to the coupler, transmit a second optical signal corresponding to another of the two optical signals and have an optical delay path which is asymmetrical to the first optical delay path; and
a polarization rotation reflection device connected to the first optical waveguide and the second optical waveguide, wherein
the polarization rotation reflection device reflects the first optical signal and the second optical signal, rotates a polarization of the first optical signal and a polarization of the reflected first optical signal and rotates a polarization of the second optical signal and a polarization of the reflected second optical signal.

11. The reflective type optical delay interferometer apparatus of claim 10, wherein the polarization rotation reflection device rotates each of the polarization of the first optical signal and the polarization of the reflected first optical signal by an angle of 45 degrees only in one direction regardless of a traveling direction of the first optical signal such that the first optical signal experiences a total polarization rotation of 90 degrees, and
the polarization rotation reflection device rotates each of the polarization of the second optical signal and the polarization of the reflected second optical signal by an angle of 45 degrees only in one direction regardless of a traveling direction of the second optical signal such that the second optical signal experiences a total polarization rotation of 90 degrees.

12. The reflective type optical delay interferometer apparatus of claim 10, wherein the polarization rotation reflection device comprises:
a lens array configured to make the first optical signal and the second optical signal to travel in parallel;
a polarization rotation device configured to rotate each of the polarizations of the first optical signal and the second optical signal, which have passed the lens array, by an angle of 45 degrees only in one direction regardless of a traveling direction of the first optical signal and the second optical signal; and
a minor configured to reflect the first optical signal and the second optical signal, which have passed through the polarization rotation device.

13. The reflective type optical delay interferometer apparatus of claim 10, wherein the second waveguide has a path longer than a path of the first waveguide, is provided in a spiral shape and is provided in a structure in which a path crossing is made on the second waveguide.

14. The reflective type optical delay interferometer apparatus of claim 13, wherein the second waveguide is provided in a rectangular crossing structure having rounded corners or provided in a circular crossing structure.

15. The reflective type optical delay interferometer apparatus of claim 10, wherein the reflective type optical delay interferometer apparatus is a time division optical interferometer of a transmission unit and a reception unit included in a quantum key distribution (QKD) system.
